(19) United States
(12) Patent Application Publication
(10) Pub. No.: US 2026/0203005 A1
(43) Pub. Date: Jul. 16, 2026

(54) METHOD AND SYSTEM FOR SELECTIVELY DISPLAYING AUDIOVISUAL CONTENT FROM A COMPUTING DEVICE

(71) Applicants: BARCO N.V., Kortrijk (BE); BARCO LIMITED, New Taipei City (TW)

(72) Inventors: Wouter DEVINCK, Kortrijk (BE); Donny TYTGAT, Kortrijk (BE); Adrien DECOSTRE, Kortrijk (BE); Cheling HUANG, New Taipei City (TW); Jui Yen CHANG, New Taipei City (TW); Pei Kuo CHAO, New Taipei City (TW)

(73) Assignees: BARCO N.V., Kortrijk (BE); BARCO LIMITED, New Taipei City (TW)

(21) Appl. No.: 19/134,920

(22) PCT Filed: Dec. 22, 2023
(86) PCT No.: PCT/EP2023/087736

§ 371 Date: Jun. 2, 2025

(30) Foreign Application Priority Data
Dec. 23, 2022 (LU) LU103055

(51) Int. Cl. G06F 3/14; G06F 3/04842; G09G 5/38

(52) U.S. Cl. CPC G06F 3/1431; G06F 3/04842; G09G 5/38; G09G 2370/12; G09G 2370/16

(57) ABSTRACT

Methods, computers, peripherals, and systems for selectively displaying audiovisual content from a computing device on a shared display, the computing device having a primary display, the computing device further being capable of controlling a secondary display. The methods including at the computing device: sending a first image signal representing a first screen image to the primary display; obtaining a selection of one or more elements to be shared; and generating a second image signal representing a second screen image for display at the secondary display, the second screen image including a representation of the one or more elements.

### FIELD OF THE INVENTION

The present invention pertains to the field of screen sharing, a practice that is commonly observed in real or virtual conferences, where a participant may wish to share content originating from their own computer with the other participants via a shared display or projection system. The present invention pertains to methods, systems, and devices for use in this field.

### BACKGROUND

Selectively sharing content to a shared display typically requires the user to run proprietary software on the user device before the content can be shared. If the software is not executed, the content will not be shared.

A known way to circumvent the proprietary software requirement, is to expose the shared display as an external screen to the user device. By using USB-C alternate mode for instance, one can create a USB-C dongle that simulates an external display. By doing so, the user device can send content through this channel without the requirement of executing proprietary software as an external display is natively supported by most common operating systems.

The disadvantage with this state-of-the-art technique is that user intervention is required to share specific content, whereby there is a risk that more content is shared than was intended. A (virtual) external display is added to the user device and everything that the user places on that external display will be shared. Sharing an individual application thus requires that the user places this application on the respective display in full-screen mode, while running the risk that other windows and/or notifications are still shared without the user's consent.

In addition, in the known methods and systems, the shared content can only be shown “as is”; it is not possible to alter the content in order to present it in a more dynamic manner to the other participants.

In view of the above, there is still a need for better methods and systems for selectively displaying audiovisual content from a computing device.

### SUMMARY

The present invention pertains to methods of selectively displaying audiovisual content from a computing device on a shared display as defined by independent claims 1, 7, and 12.

While these different aspects of the invention share certain common features, as will be described in detail below, they solve the problems related to contents sharing in alternative ways. The present invention also pertains to a computer program product as defined by claim 17; to a computer as defined by claim 18; to a peripheral as defined by claim 19; and to a system as defined be claim 20.

The various aspects of the present invention have in common that there is provided a method of selectively displaying audiovisual content from a computing device on a shared display, the computing device having a primary display, the computing device further being capable of controlling a real or virtual secondary display, the method comprising at the computing device:
sending a first image signal representing a first screen image to the primary display;
obtaining a selection of one or more elements to be shared; and
generating a second image signal representing a second screen image for display at the secondary display, the second screen image including a representation of the one or more elements.

It is an advantage of the different aspects of the invention that it relies on most operating systems'inherent ability to control a secondary display.

The user may select which content is to be shared. To this end, the computing device may show a selection interface. Additionally or alternatively, the selection can be prepared, proposed, or made by software running on the computing device.

The content to be shared is included in a signal that is prepared for the secondary display. Additional processing may be performed on the selected content, to comply with the user's privacy requirements and to optimize viewing. Such processing may take place prior to the generating of the aforementioned signal, or at a device mimicking a display, functionally placed between the computing device and the actual shared display (whereby that device may be physically integrated with the shared display). It should be noted that, as long as no selection has been made or when all previously selected elements have been deselected, the signal prepared for the secondary display may simply represent a blank screen (e.g. filled with black color or a chosen background color, a company logo, an inspiring quote, the time of day, or the like).

The elements selected for sharing may be application windows (e.g., a single window, several windows belonging to the same application, or windows belonging to different applications) or other application contents (which may include audio content), files that can be graphically rendered, streams, and/or geometrically defined areas of the image shown on the primary display. The geometrically defined areas are preferably polygons, and more preferably rectangles, and most preferably rectangles with sides that are aligned with the main axes of the primary display's pixel grid.

The shared display may be any external display that serves the needs of the environment where it is being used. It may in particular be an LCD display, an LED display, a plasma display, a projector, or a display operating according to any other principle. The shared display is not necessarily a 2D display, but may also be a (autostereoscopic) stereo display, a volumetric display, or the like. In certain applications, the shared display may be embodied as a headset, a room audio system, a haptic actuator, etc.

In a first aspect of the present invention, the shared display is operatively connected to the computing device and the computing device is configured to control the shared display as the secondary display; the computing device is configured to generate the first screen image and the second screen image independently; and the generating of the second image signal comprises placing the representation of the one or more elements in an image space covered by the secondary display.

It is an advantage of this aspect that the computing device can be directly connected to the shared display in the conventional way, whereby any suitable type of video connector may be used.

This aspect is based on the insight of the inventor that when this display mode is used, the operating system retains control over the secondary display and hence, software can be provided to interact with the operating system in such a way as to place any desired content on the secondary display (even in “full-screen mode”, such that even a task bar, notification area, and the like are no longer visible), independently of what is being shown on the primary display. The second image signal can thus be generated to contain a clean image showing only the elements selected for sharing. As the applications whose graphical output is to be shared are running on the computing device itself, windows and other content pertaining to these applications can be included in the second image signal, even if they are not or not fully visible on the primary display.

In a particular embodiment, the computing device is configured to generate the first screen image and the second screen image so as to represent respective parts of a virtual area.

In this embodiment, the computing device is configured to generate the first screen image and the second screen image so as to represent respective parts of a virtual area. This way of controlling a secondary display is commonly available in existing operating systems and may be used to generate the illusion of a single, contiguous desktop area spread over two displays, whereby objects can typically be dragged from one display to another as if they are moving in one continuous space.

In a particular embodiment, the method further comprises, at the computing device: processing the one or more elements prior to the generating of the second image signal, by performing one or more of:
altering relative or absolute positions of the one or more elements;
scaling the one or more elements;
altering a title bar of an application window comprised in the one or more elements;
altering a menu bar of an application window comprised in the one or more elements;
altering a portion of one of the one or more elements that is not associated with a main application window comprised in the one of the one or more elements
altering a portion of the one or more elements in order to adapt to the current context; and
altering a portion of the one or more elements that is determined to contain sensitive information.

It is an advantage of this embodiment that the rendering of the shared elements can be optimized for privacy and viewing.

In a particular embodiment, the generating of the second image signal comprises combining the one or more elements with content received from a different source.

It is an advantage of this embodiment that fancy layouts can be generated using content from the computing device and from other sources (e.g., from other users, from a server, from a broadcast, from the internet, etc.). The resulting layouts may include overlays, mosaics, picture-in-picture displays and the like. At this stage, the shared elements, which have optionally been processed as described above, may be further scaled, translated, rotated, etc. to allow for their combination with the other content.

In a particular embodiment, the shared display is connected to the computing device by means of one of an analog video connector, a DVI connector, an HDMI connector, and a USB-C connector preferably operating according to alternate mode.

In a particular embodiment, the computing device is equipped with a wireless dongle, wherein the shared display comprises or is connected to a wireless receiver, and wherein the operative connection between the computing device and the shared display includes a wireless link between the wireless dongle and the wireless receiver.

The wireless dongle may be connected to the computing device by means of a USB-C connection. The wireless receiver may also be dongle-type device connected to the shared display (e.g., by means of another USB-C connection), or it may be a receiver integrated in the shared display itself or in a separate device performing other functions.

In a second aspect of the present invention, the shared display is operatively connected to an intermediary device and the intermediary device is operatively connected to the computing device, the computing device being configured to control the intermediary device as the secondary display; the computing device is configured to use a copy of the first screen image as the second screen image. The method further comprises, at the computing device: sending information indicative of the selection to the intermediary device. The method further comprises, at the intermediary device: extracting the one or more elements from the second screen image in accordance with the information indicative of the selection; generating a third image signal representing a third screen image, the third screen image including a representation of the one or more elements; sending the third image signal to the shared display connected to the intermediary device.

It is an advantage of this aspect that the computing device is connected to the shared display via an intermediate device, which provides all the logic required to ensure a smooth and secure sharing experience. This avoids the need for additional software on the user's own computing device, other than for receiving the user's selection and passing it on as metadata to the intermediary device.

In this aspect, the computing device is configured to send substantially the same image to the secondary display (in this case, the intermediary device) as is being shown on the primary display, i.e. the image of the primary display is cloned on the secondary display.

This aspect is based on the insight of the inventor that when this display mode is used, the intermediary device has the complete contents of the primary display at its disposal, as comprised in the second display signal. Using that information and knowledge of the user's selection, a third image signal can thus be generated to contain a clean image showing only the elements selected for sharing. This third signal can then be sent to the actual shared display.

In a particular embodiment, the method further comprises, at the intermediary device:
processing the one or more elements prior to the generating of the third image signal, by performing one or more of:
altering relative or absolute positions of the one or more elements;
scaling the one or more elements;
altering a title bar of an application window comprised in the one or more elements;
altering a menu bar of an application window comprised in the one or more elements;
altering a portion of one of the one or more elements that is not associated with a main application window comprised in the one of the one or more elements;
altering a portion of the one or more elements in order to adapt to the current context; and
altering a portion of the one or more elements that is determined to contain sensitive information.

It is an advantage of this embodiment that the rendering of the shared elements can be optimized for privacy and viewing.

In a particular embodiment, the method further comprises, at the computing device: sending processing instructions to the intermediary device; and at the intermediary device: processing the one or more elements prior to the generating of the third image signal in accordance with the processing instructions.

It is an advantage of this embodiment that the user can be given more control over the way the shared image is presented. The user can interact with the computing device, which relays processing instructions to the intermediary device.

In a particular embodiment, the generating of the third image signal comprises combining the one or more elements with content received from a different source.

It is an advantage of this embodiment that fancy layouts can be generated using content from the computing device and from other sources (e.g., from other users, from a server, from a broadcast, from the internet, etc.). The resulting layouts may include overlays, mosaics, picture-in-picture displays and the like. At this stage, the shared elements, which have optionally been processed as described above, may be further scaled, translated, rotated, etc. to allow for their combination with the other content.

In a particular embodiment, the intermediary device is connected to the computing device by means of a USB-C connector, operating according to alternate mode.

While selection information and other metadata can generally be transmitted from the computing device to the intermediary device via a channel that is completely independent from the channel used to transmit the image signal, this embodiment takes advantage of the fact that USB-C can be used to transport both the video signal and the necessary metadata to enable the intermediary device to carry out its functions.

In a third aspect of the present invention, the shared display is operatively connected to an intermediary device and the intermediary device is operatively connected to the computing device, the computing device being configured to control the intermediary device as the secondary display; the computing device is configured to generate the first screen image and the second screen image independently; the generating of the second image signal comprises placing the representation of the one or more elements in an image space covered by the secondary display. The method further comprises, at the computing device: sending information indicative of the placement of the representation of the one or more elements to the intermediary device. The method further comprises, at the intermediary device: extracting the one or more elements from the second screen image in accordance with the information indicative of the placement; generating a third image signal representing a third screen image, the third screen image including a representation of the one or more elements; and sending the third image signal to the shared display connected to the intermediary device.

It is an advantage of this aspect that the computing device is connected to the shared display via an intermediate device, as described above in the context of the second aspect of the invention. However, the computing device is configured to generate the first screen image and the second screen image independently, as described above in the context of the first aspect of the invention. As in the first aspect of the invention, windows pertaining to selected applications can be included in the second image signal, even if they are not or not fully visible on the primary display. This allows the intermediary device to generate a third image signal containing a clean image showing the elements selected for sharing in full.

In a particular embodiment, the computing device is configured to generate the first screen image and the second screen image (122) so as to represent respective parts of a virtual area.

In a particular embodiment, the method further comprises, at the intermediary device:
processing the one or more elements prior to the generating of the third image signal, by performing one or more of:
altering relative or absolute positions of the one or more elements;
scaling the one or more elements;
altering a title bar of an application window comprised in the one or more elements;
altering a menu bar of an application window comprised in the one or more elements;
altering a portion of one of the one or more elements that is not associated with a main application window comprised in the one of the one or more elements;
altering a portion of the one or more elements in order to adapt to the current context; and
altering a portion of the one or more elements that is determined to contain sensitive information.

It is an advantage of this embodiment that the rendering of the shared elements can be optimized for privacy and viewing.

In a particular embodiment, the generating of the third image signal comprises combining the one or more elements with content received from a different source.

It is an advantage of this embodiment that fancy layouts can be generated using content from the computing device and from other sources (e.g., from other users, from a server, from a broadcast, from the internet, etc.). The resulting layouts may include overlays, mosaics, picture-in-picture displays and the like. At this stage, the shared elements, which have optionally been processed as described above, may be further scaled, translated, rotated, etc. to allow for their combination with the other content.

In a particular embodiment, the intermediary device is connected to the computing device by means of a USB-C connector, operating according to alternate mode.

According to an aspect of the present invention, there is provided a computer program product comprising code means configured to cause a computer to perform the steps to be performed by the computing device in embodiments of the method according to the present invention described above.

According to an aspect of the present invention, there is provided a computer configured to perform the steps to be performed by the computing device in embodiments of the method according to the present invention described above.

According to an aspect of the present invention, there is provided a peripheral configured to perform the steps to be performed by the intermediary device in embodiments of the method according to the present invention described above.

According to an aspect of the present invention, there is provided a system for selectively displaying audiovisual content, the system comprising: a computer configured to perform the steps to be performed by the computing device in embodiments of the method according to the present invention described above; and a peripheral, operatively connected to the computer and configured to perform the steps to be performed by the intermediary device in embodiments of the method according to the present invention described above; and a display, operatively connected to the peripheral.

The technical effects and advantages of embodiments of the computer program product, the computer, the peripheral, and the system according to the present invention correspond mutatis mutandis to those of the corresponding embodiments of the method according to the present invention.

### BRIEF DESCRIPTION OF THE DRAWINGS

These and other features and effects of embodiments of the present invention will now be described in more detail with reference to the enclosed Figures, in which:

FIGS. 1 and 2 schematically present systems in which certain embodiments of the first aspect of the present invention may be applied;

FIG. 3 presents a flow chart of an embodiment of the first aspect of the present invention;

FIGS. 4a and 4b present examples of the first screen image and the second screen image in an embodiment of the first aspect of the present invention;

FIGS. 5, 6, 7, 8, 9, and 10 schematically present systems in which embodiments of the second aspect of the present invention may be applied;

FIG. 11 presents a flow chart of an embodiment of the second aspect of the present invention;

FIGS. 12a and 12b present examples of the first screen image and the third screen image in an embodiment of the second aspect of the present invention;

FIG. 13 presents a flow chart of an embodiment of the third aspect of the present invention; and

FIG. 14 presents examples of the first screen image, the second screen image, and the third screen image in an embodiment of the third aspect of the present invention.

### DESCRIPTION OF EMBODIMENTS

In the attached figures, embodiments of the method according to the present invention are presented as flow charts. The order of the steps shown in the flow charts is illustrative and not meant to restrict the invention, unless the present description or the nature of the steps indicates that one step necessarily follows another step.

For the sake of clarity and brevity, certain optional steps of embodiments of the methods according to aspects of the present invention which happen on the computing device 110 will be described hereinafter as being carried out by “sharing software”. The skilled person will appreciate that these steps may generally be carried out by software running on the computing device 110, by actions of the operating system of the computing device 110, by a user interacting with the computing device 110, or a combination thereof.

With reference to the attached figures, the various aspects of the present invention have in common that they allow selectively displaying audiovisual content from a computing device 110 on a shared display 140. The computing device 110 has a primary display 120, and is further being capable of controlling a secondary display. The method comprises at the computing device 110: sending 1010 a first image signal representing a first screen image 121 to the primary display 120; obtaining 1020 a selection of one or more elements to be shared; and generating 1040 a second image signal representing a second screen image 122 for display at the secondary display, the second screen image 122 including a representation of the one or more elements.

The computing device 110 may be any type of digital device, such as, without limitation, a personal computer (e.g. a desktop computer, a laptop computer, a notebook computer, or a personal digital assistant) or a mobile device (e.g., a smartphone or a tablet). The computing device 110 may have a user interface that allows it to receive input from a user.

Obtaining 1020 the selection of elements to be shared may involve operating a selection interface. The selection interface may be a function of the sharing software that allows the user to select an application window already shown on the primary display, to select a file (e.g. a text file, a graphical file, a video file, etc.) to be rendered by the sharing software specifically for the purpose of sharing it, or to select a region of the first screen image for sharing (e.g. by dragging the mouse to draw the shape of the region to be shared, a function generally known in graphical software as the “select” or “lasso” tool). The selection interface may include well-known GUI elements such as menus, checkboxes, wizards, and the like. Additionally or alternatively, the selection can be prepared, proposed, or made by software running on the computing device, based on a pre-programmed configuration, stored user preferences, or even by applying an artificially intelligent agent that uses rules and/or machine learning to detect patterns in the sharing selection of users.

When certain content is selected for sharing, the sharing software may cause the rendering of the content to be modified at the application level prior to subjecting said content to subsequent steps of the sharing process. For example, the sharing software may cause an application window selected for sharing to be resized by the window manager of the operating system, so as to obtain a properly formatted version of the window at the desired size, without the image distortion that would otherwise result from graphically resizing the original application window. The sharing software may cause application windows to be reordered on the desktop in a tiled arrangement to remove overlap that would otherwise occlude portions of selected windows.

The image signals referred to in the present description may represent traditional two-dimensional video, but also mono/stereo/n-channel audio, 2D+Z video, volumetric video, segmented video, haptic signals, and combinations thereof, in function of the capabilities of the shared display.

It shall be understood that the shared display 140 may be embodied by a combination of different functional components, for example a display as such and additional conferencing equipment with wireless connectivity capabilities (e.g. in the form of an all-in-one conferencing bar). The shared display 140 may also be a so-called all-in-one display with built-in conferencing and wireless connectivity capabilities.

It should be noted that the secondary display may be exposed on the computing device via a virtual means. For example, an operating system may allow software to send image content to a virtual display via a protocol like Google Chromecast, without exposing the virtual display to the end user in the same way as the primary display.

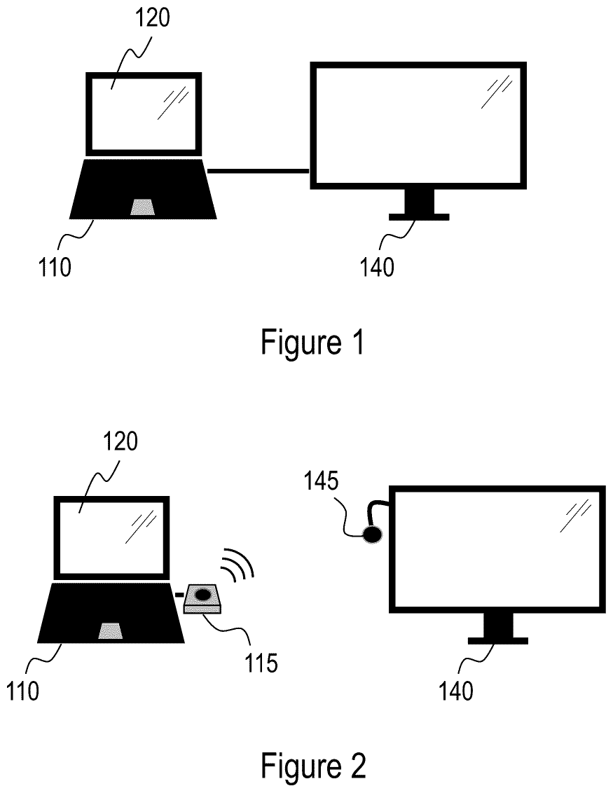

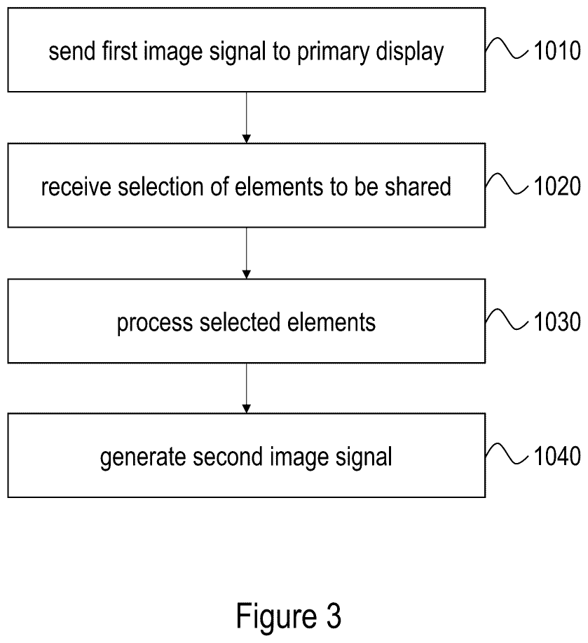

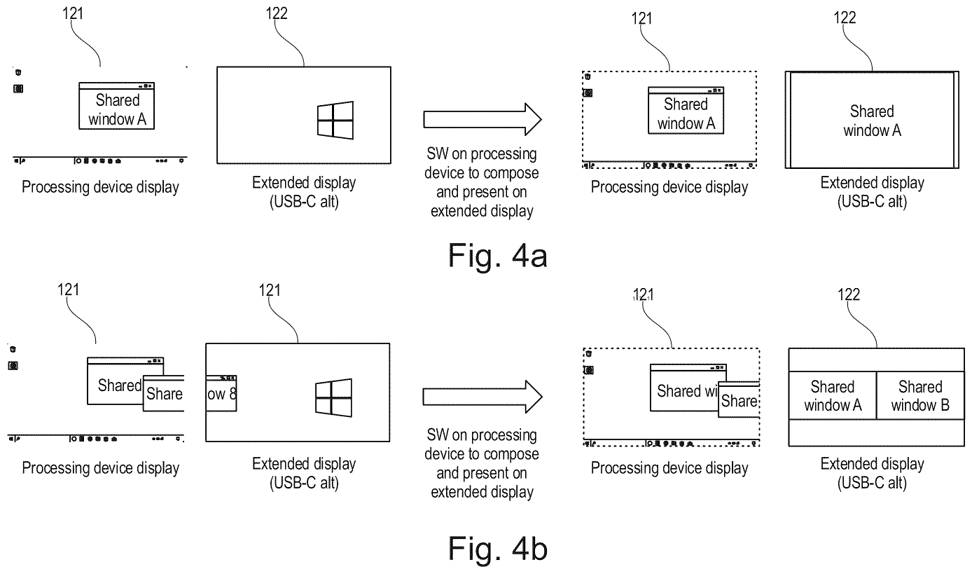

A first aspect of the invention will now be described with reference to the systems schematically illustrated in FIGS. 1 and 2, the flow chart of FIG. 3, and the exemplary screen layouts of FIGS. 4a-b. In these set-ups, the shared display 140 is operatively connected to the computing device 110 and the computing device 110 treats the shared display 140 as its secondary display.

The operative connection between the computing device 110 and the shared display 140 may be realized by means of wired point-to-point connection, a shown in FIG. 1, for example by means of an analog video connector, a DVI connector, an HDMI connector, a USB-C connector, or the like. Alternatively, the operative connection between the computing device 110 and the shared display 140 may be realized by means of a wireless connection, as shown in FIG. 2, where the computing device 110 is equipped with a dongle 115 (preferably connected to the computing device 110 by means of a USB-C connection) which transmits the second image signal to the wireless receiver 145 connected to or integrated in the shared display 140. The wireless connection between dongle 115 and receiver 145 may use a proprietary protocol, a video transport protocol, or a wireless video casting protocol such as Miracast, Apple AirPlay, Google Chromecast, or the like, operating over a wireless local area networking protocol, such as IEEE Std 802.11 (“Wi-Fi”), or a wireless personal area networking protocol, such as IEEE Std 802.15 (“Bluetooth”).

If USB-C is used, the second video signal may be transmitted via USB alternate mode (e.g., using Display Port or Thunderbolt), while the metadata (selection data and optionally processing instructions) may be transmitted through a side channel such as USB. Metadata can also be sent via the auxiliary channels of Display Port or Thunderbolt, or separate channels such as Bluetooth, Wi-Fi, Ethernet, etc., or the metadata can be encoded in the second video signal as a (hidden) signal that can be decoded later on.

With reference to FIG. 3, the video sharing takes place as follows: the computing device 110 is configured to generate the first screen image and the second screen image independently. In the illustrated case, the screen images are generated so as to represent respective parts of a virtual area (i.e., the image space covered by the primary display 120 and the image space covered by the secondary display are virtually contiguous), and the generating 1040 of the second image signal comprises placing the representation of the one or more elements in the part of the virtual area displayed by the secondary display.

While this aspect of the invention is not limited thereto, the illustrated embodiment thus uses the “desktop extension” mode of driving the secondary display of the computing device 110, whereby the sharing software preferably causes the entire screen area of the secondary display to be covered by a suitably arranged rendering of the element(s) to be shared. However, for the purposes of this embodiment, the user of the computing device 110 is preferably not made aware of the presence of a secondary display; while the secondary display is present and controlled at the level of the operating system, and made available for the purpose of sharing, the sharing software preferably prevents the end user from experiencing this virtual secondary display as an extension of their desktop. This may be achieved by monitoring the user-initiated movements of the mouse cursor and forcing the mouse cursor to remain in or return to the territory of the primary display when the territory of the secondary display would be reached. Alternatively, the rendering of the shared elements may be suspended when the user moves the mouse cursor into the territory of the secondary display, such that the secondary display (the signal of which is shown on the shared display 140) can be made to resume its role as a desktop extension under control of the user. In addition, the user may be prevented from actively positioning content on the secondary display, or content that is placed there by the user may be automatically repositioned on the primary display. Where the operating system allows this, the existence of the secondary display may be made completely invisible to the user.

Preferably, the one or more elements are processed 1030 at the computing device 110 prior to the generating 1040 of the second image signal, by performing one or more of the following:
Altering relative or absolute positions of said one or more elements. This may involve centering an element, moving elements relative to each other to obtain a more suitable arrangement, placing elements in a grid, etc.
Scaling said one or more elements. This may include expanding an element with a view to using the largest possible amount of the available screen real estate, or compressing elements in order to fit more elements on the screen. The scaling factors may be different for different elements. The scaling factors are not necessarily the same for the x-direction and the y-direction.
Altering a title bar of an application window comprised in said one or more elements. As application title bars can include sensitive information such as file names or user names, it may be advisable to remove such title bars prior to rendering. Where multiple shared application windows are displayed in a tiled manner, the removal of the title bars will allow for a tighter arrangement. The sharing software may provide alternative labels to identify elements from which the original title bars have been removed.
Altering a menu bar of an application window comprised in said one or more elements. As the content rendered at the shared display 140 is meant for viewing only, any menu bars included in a shared application windows would be non-functional. Where multiple shared application windows are displayed in a tiled manner, the removal of the menu bars will allow for a tighter arrangement.
Altering a portion of one of said one or more elements that is not associated with a main application window comprised in said one of said one or more elements.
Altering a portion of the one or more elements in order to adapt to the current context. Context may include, without limitation, an operational context (e.g. adapting framerate/resolution to facilitate network conditions, computational restrictions or physical restrictions), a viewing context (e.g. adapting the elements to aid better viewing), a social context (e.g. translate contents towards shared screen audience), etc.
Altering a portion of said one or more elements that is determined to contain sensitive information.

FIG. 4a presents an example of contents of the primary display 120 of the computing device 110 (i.e., a first screen image 121), in which one specific application window (labeled “Shared window A”) is selected for sharing. The computing device 110 operates a secondary screen in “desktop extension” mode, thus creating a second screen image 122 that will be displayed on the shared display 140. Initially, the second screen image 122 would just be a portion of the extended desktop (left side of the white arrow). Preferably, the sharing software controls the mouse cursor so as to prevent the user from actually using the secondary display portion (which would be shown on the shared display 140) as part of the desktop, as described in more detail above. The sharing software receives 1020 the user's selection of content to be shared, and renders 1040 that content on second screen image 122, so as to be shown on the shared display 140 (right side of the white arrow). Prior to said rendering 1040, the shared content may be processed 1030. In the illustrated example, the applied processing 1030 includes removing the title bar from the application window, scaling the shared window to take up a maximum amount of the second screen image 122, and placing the scaled shared window on a neutral background so as to fill the entire screen of the shared display 140.

FIG. 4b presents another example of contents of the primary display 120 of the computing device 110 (i.e., a first screen image 121), in which two specific application windows (labeled “Shared window A” and “Shared window B”) are selected for sharing. The computing device 110 operates a secondary screen in “desktop extension” mode, thus creating a second screen image 122 that will be displayed on the shared display 140. Initially, in the absence of sharing in accordance with the present invention, the second screen image 122 would just be a portion of the extended desktop (left side of the white arrow). Preferably, the sharing software controls the mouse cursor so as to prevent the user from actually using the secondary display portion (which would be shown on the shared display 140) as part of the desktop, as described in more detail above. The sharing software obtains 1020 the selection of content to be shared, for example by getting the user's selection through a selection interface, and renders 1040 that content on second screen image 122, so as to be shown on the shared display 140 (right side of the white arrow). Prior to said rendering 1040, the shared content may be processed 1030. In the illustrated example, the applied processing 1030 includes removing the title bars from the shared application windows, scaling the shared windows to the same size, positioning them side-by-side, and placing the scaled shared windows on a neutral background so as to fill the entire screen of the shared display 140.

It should be noted that the rendering of content on the shared display 140 is independent of what is shown on the primary display 120. Thus, it is immaterial that the “Shared window B” is not fully contained in the first screen image 121. As the sharing is performed by sharing software running on the computing device 110, it is possible to locally access application information and files, and render the content to be shared directly onto the secondary display for sharing purposes.

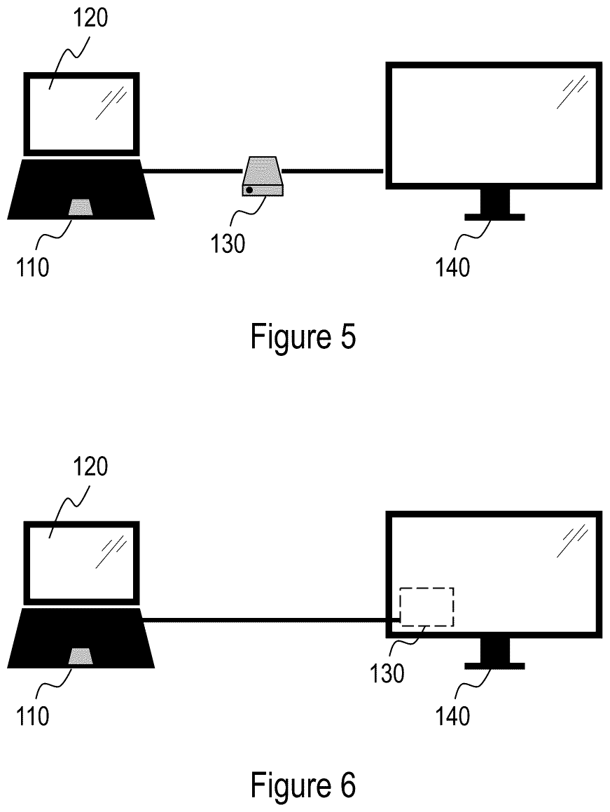

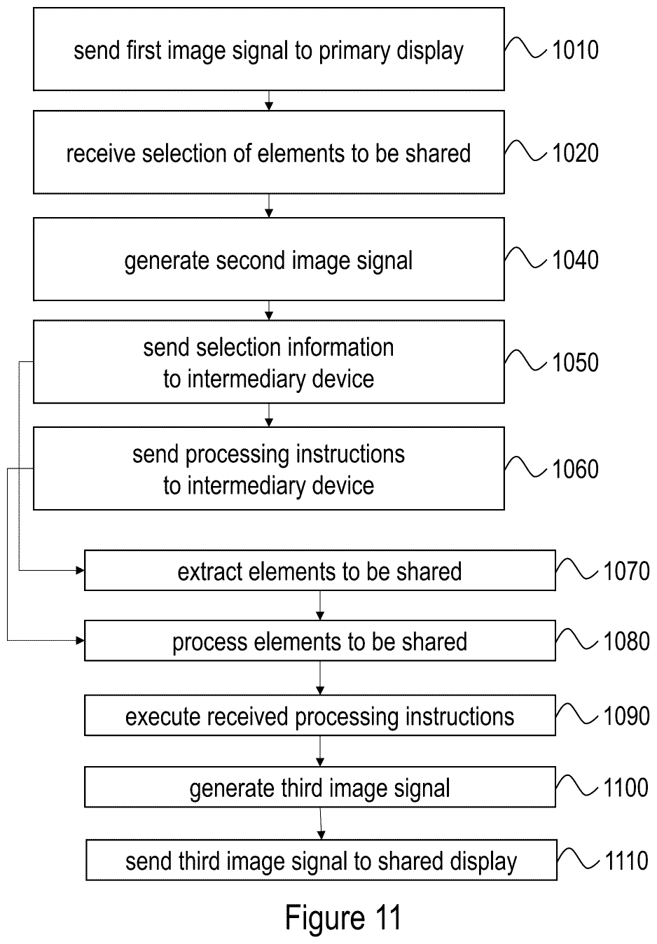

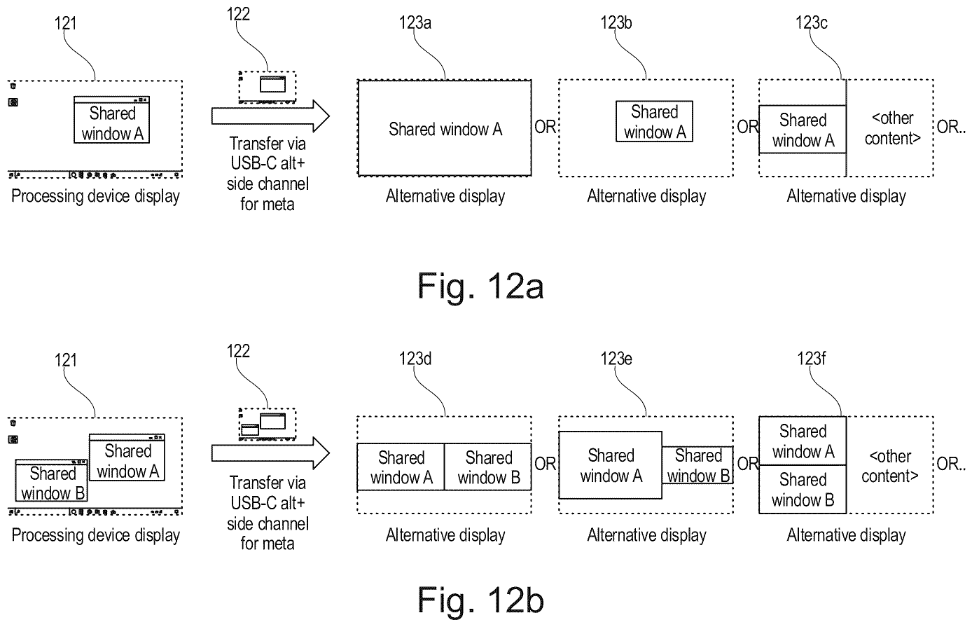

A second aspect of the invention will now be described with reference to the systems schematically illustrated in FIGS. 5-10, the flow chart of FIG. 11, and the exemplary screen layouts of FIGS. 12a-b. In these set-ups, the shared display 140 is operatively connected to an intermediary device 130 and the intermediary device 130 is connected to the computing device 110. The computing device 110 is configured to control the intermediary device 130 as its secondary display. The intermediary device 130 preferably presents itself to the computing device 110 as a display device, to receive the display signal, and as a data receiver, to receive metadata (in particular, selection information, and optionally processing instructions, as will be described in more detail below). The intermediary device 130 may be a separate device, as shown in FIGS. 5, 8, and 9; a function integrated in the shared display 140, as shown in FIGS. 6, 7, and 10; or a function integrated in another separate device that also offers other functionalities, such as an all-in-one conferencing bar (not illustrated).

Accordingly, the operative connection between the computing device 110 and the intermediary device 130 may be realized by means of digital wired point-to-point connection, as shown in FIGS. 5, 6, and 8, preferably a USB-C connection operating in alternate mode. If USB-C is used, the second video signal may be transmitted via USB alternate mode (e.g., using Display Port or Thunderbolt), while the metadata (selection data and optionally processing instructions) may be transmitted through a side channel such as USB. Metadata can also be sent via the auxiliary channels of Display Port or Thunderbolt, or separate channels such as Bluetooth, Wi-Fi, Ethernet, etc., or the metadata can be encoded in the second video signal as a (hidden) signal that can be decoded later on.

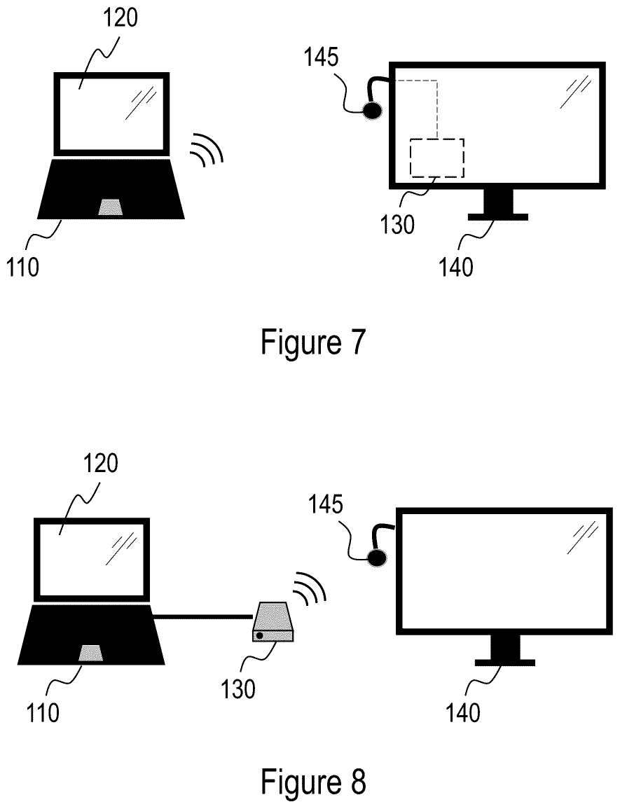

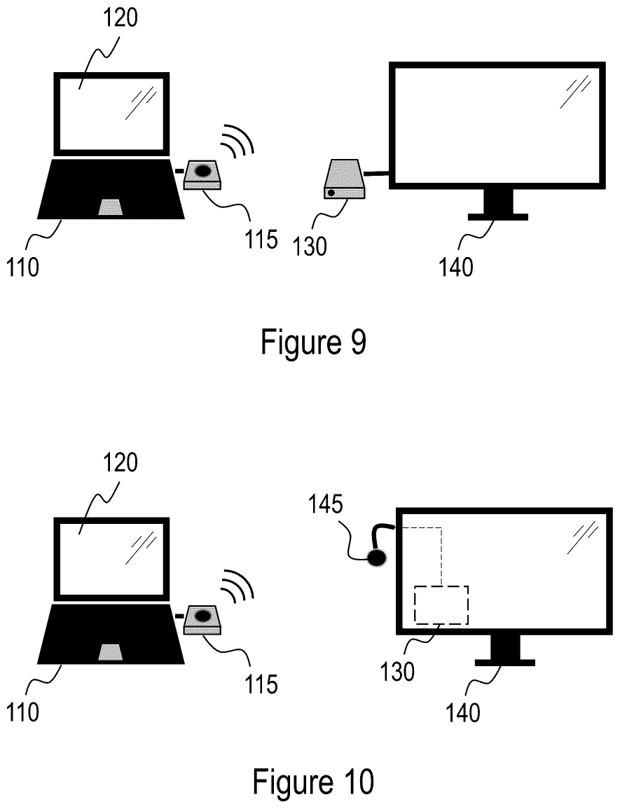

Alternatively, the operative connection between the computing device 110 and the intermediary device 130 may be realized by means of a digital wireless connection in a variety of ways, some of which are illustrated in FIGS. 7, 9, and 10. The computing device 110 may be equipped with a dongle 115 (FIGS. 9 and 10) or an internal transceiver (FIG. 7) which transmits the second image signal to the wireless receiver 145 connected to or integrated in the shared display 140, if the latter hosts an integrated intermediate device 130 (FIGS. 7 and 10), or to the internal transceiver of the intermediary device 130 itself, if it is a separate device (FIG. 9). The wireless connection between computing device 110 or its dongle 115 and receiver 145 or intermediary device 130 may use a proprietary protocol, a video transport protocol, or a wireless video casting protocol such as Miracast, Apple AirPlay, Google Chromecast, or the like, operating over a wireless local area networking protocol, such as IEEE Std 802.11 (“Wi-Fi”), or a wireless personal area networking protocol, such as IEEE Std 802.15 (“Bluetooth”).

If the intermediary device 130 is not integrated in the shared display 140, the operative connection between the intermediary device 130 and the shared display 140 may be realized by means of a wired point-to-point connection, as shown in FIG. 5, for example by means of an analog video connector, a DVI connector, an HDMI connector, a USB-C connector, or the like. Alternatively, the operative connection between the intermediary device 130 and the shared display 140 may be realized by means of a wireless connection, as shown in FIG. 8, where the intermediary device 110 is equipped with an internal transceiver which transmits the second image signal to the wireless receiver 145 connected to or integrated in the shared display 140. As before, the wireless connection between intermediary device 130 and receiver 145 may use a wireless video casting protocol such as Miracast, Apple AirPlay, Google Chromecast, or the like, operating over a wireless local area networking protocol, such as IEEE Std 802.11 (“Wi-Fi”), or a wireless personal area networking protocol, such as IEEE Std 802.15 (“Bluetooth”).

With reference to FIG. 11, the video sharing takes place as follows: the computing device 110 is configured to use a copy of the first screen image as the second screen image, which is sent to the intermediary device 130, and the computing device 110 also sends 1050 information indicative of the selection to the intermediary device 130. The intermediary device 130 extracts 1070 the one or more elements from the second screen image in accordance with the information indicative of the selection. The intermediary device 130 then generates 1100 a third image signal representing a third screen image, the third screen image including a representation of the one or more elements. The intermediary device 130 then sends 1110 the third image signal to the shared display 140 connected to the intermediary device 130.

This embodiment thus relies on the “desktop cloning” mode of driving the secondary display of the computing device 110, whereby the intermediary device 130 receives a substantially identical copy of the contents of the primary display 120 of the computing device 110. The intermediary device 130 can therefore selectively copy and rearrange elements of the screen image of the primary display 120 to prepare a screen image for sharing. It is a limitation of this embodiment that elements that are not visible on the primary display 120, e.g. occluded portions of application windows or images stored on the computing device 110 but not actively being rendered, are not accessible to the intermediary device 130 for sharing. Portions of the shared elements that are missing or filled with irrelevant content because of occlusion or overlap on the primary display 120, can be restored or repaired at the intermediate device 130. The restoration/repair process at the intermediate device 130 is preferably based on additional metadata received from the computing device 110 identifying the affected areas and optionally the content with which the affected areas should be replaced. In the absence of information on the content with which the affected area or areas should be replaced, the intermediary device 110 may process the shared elements to de-emphasize the affected areas, for example by blurring them, filling them with a pattern or message indicative of missing content, or filling them with a neutral or background color.

Preferably, the one or more elements are processed 1080 at the intermediary device 130 prior to the generating 1100 of the third image signal, by performing one or more of the following:
altering relative or absolute positions of the one or more elements;
scaling the one or more elements;
altering a title bar of an application window comprised in the one or more elements;
altering a menu bar of an application window comprised in the one or more elements;
altering a portion of one of the one or more elements that is not associated with a main application window comprised in the one of the one or more elements;
altering a portion of the one or more elements in order to adapt to the current context; and
altering a portion of the one or more elements that is determined to contain sensitive information.

Optional aspects and advantages of these processing steps are described above in the context of the first aspect of the invention.

As there is a digital data communication channel available between the computing device 110 and the intermediary device 130 for relaying the selection information, it is also possible for the sharing software to relay processing instructions to the intermediary device 130. Accordingly, the method according to this embodiment may further include, at the computing device 110, sending 1060 processing instructions to the intermediary device 130; and, at the intermediary device 130, processing 1090 the one or more elements prior to the generating 1100 of the third image signal in accordance with the processing instructions.

The intermediary device 130 may act as a hub receiving and processing video and metadata in the way described above from a plurality of computing devices, and combining the shared elements adduced by the different computing devices into a third image signal including representations of either all the adduced shared elements, or a selection thereof. Without limitation, the selection could be made by the intermediary device 130 on the basis of hard-coded or configurable rules, a hierarchy between computing devices or between types of content, additional metadata sent for this purpose by one of the computing devices, an artificially intelligent agent using machine learning and user feedback to build a selection strategy.

Assuming the presence of a suitable feedback communication channel, the intermediary device 130 may further be adapted to receive instructions from the side of the shared display 140. These instructions may for instance relate to the processing 1090 of the elements to be shared and the generating 1100 of the third image signal, including, as the case may be, the selection and layout of elements adduced by different computing devices. This kind of feedback enables a usage model whereby users interact with a user interface of the shared display 140 to alter the rendering of the shared elements (this may include interacting with the shared display 140, e.g. by touching a touchscreen, to rearrange elements, zoom in on certain elements, remove elements, etc.). Further feedback communication may take place from the intermediary device 130 to the computing device 110, for example to allow the intermediary device 130 to alert the computing device 110 that a certain shared element originating from the latter has been zoomed into and to request a higher-resolution or bigger-sized version of said shared element.

FIG. 12a presents an example of contents of the primary display 120 of the computing device 110 (i.e., a first screen image 121), in which one specific application window (labeled “Shared window A”) is selected for sharing. The complete first screen image 121 is cloned as the second screen image 122, which is transmitted 1040 via an USB-C connection to the intermediary device 130 as the second image signal. A USB-C side channel is used to relay 1050 selection information from the computing device 110 to the intermediary device 130, which in this case tells the intermediate device 130 which portion of the screen image is selected for sharing. The information may be conveyed in the form of coordinates of at least two corners of the rectangle that matches the selected window. Using this selection information, the intermediary device 130 extracts 1070 the appropriate portion of the second screen image 122, processes 1080 it (in the illustrated case, this includes removing the title bar from the shared window), and renders 1100/1110 it as a third screen image 123a/b/c on the shared display 140. Examples of the processing 1080 include scaling the shared window up to cover the full screen (123a); placing the shared window on a neutral background (123b); and moving the shared window to a different screen location to free up space for other content (123c).

FIG. 12b presents another example of contents of the primary display 120 of the computing device 110 (i.e., a first screen image 121), in which two specific application windows (labeled “Shared window A” and “Shared window B”) are selected for sharing. The complete first screen image 121 is cloned as the second screen image 122, which is transmitted 1040 via an USB-C connection to the intermediary device 130 as the second image signal. A USB-C side channel is used to relay 1050 selection information from the computing device 110 to the intermediary device 130, which in this case tells the intermediate device 130 which portion of the screen image is selected for sharing. The information may be conveyed in the form of coordinates of at least two corners of the respective rectangles that match the selected windows. Using this selection information, the intermediary device 130 extracts 1070 the appropriate portions of the second screen image 122, processes 1080 them (in the illustrated case, this includes removing the title bars from the shared windows), and renders 1100/1110 them as a third screen image 123d/e/f on the shared display 140. Examples of the processing 1080 include scaling the shared windows to the same size, moving them side by side, and placing them on a neutral background (123d); scaling the shared windows differently to emphasize one window relative to the other one, moving them side by side, and placing them on a neutral background (123e); and scaling the shared windows to the same size, placing one above the other, and moving the pair to one side of the screen to free up space for other content (123f).

The way in which various shared elements are selected for effective rendering and/or represented relative to each other (relative size, positioning, and emphasis) during the rendering step 1100/1110, may, without limitation, be determined by the intermediary device 130 on the basis of hard-coded or configurable rules, a hierarchy between computing devices or between types of content, additional metadata sent for this purpose by the computing device, or an artificially intelligent agent using machine learning and user feedback to build a selection strategy.

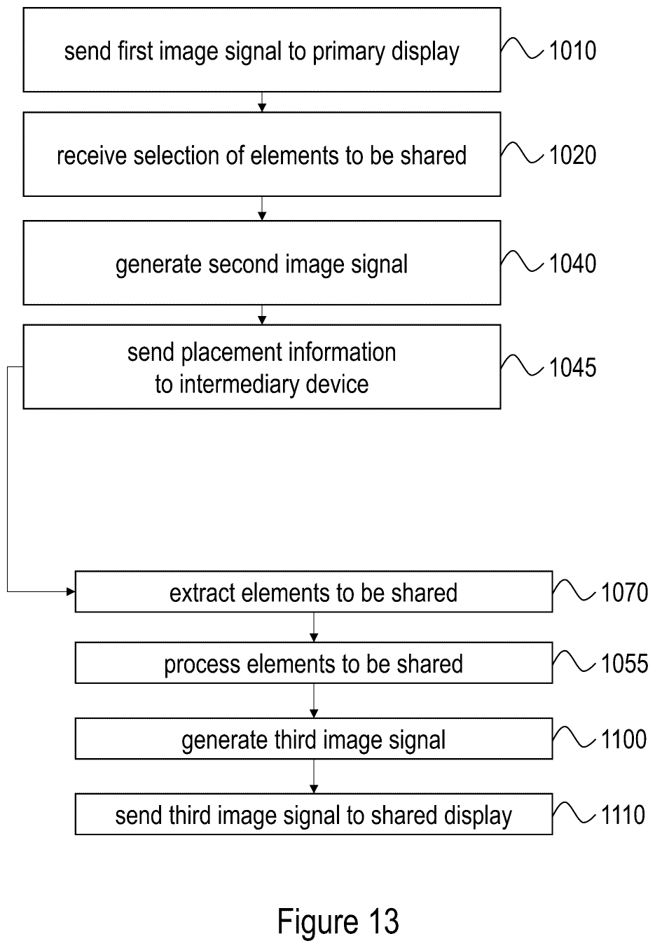

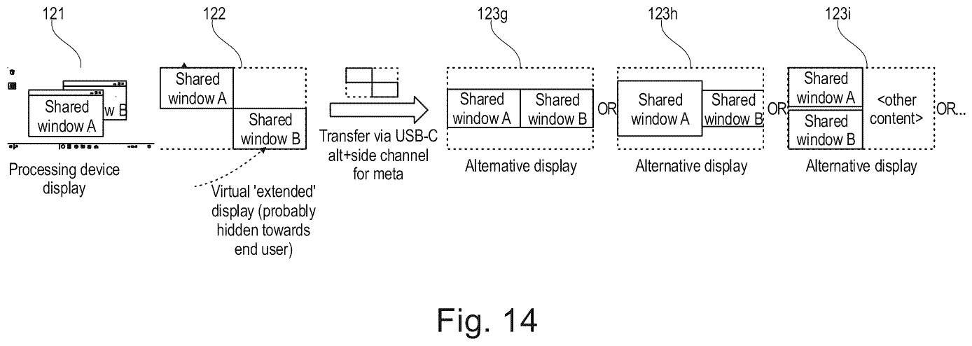

A third aspect of the invention will now be described with reference to the systems schematically illustrated in FIGS. 5-10, the flow chart of FIG. 13, and the exemplary screen layouts of FIG. 14. The description of the set-ups of FIGS. 5-10 presented above in the context of embodiments of the second aspect of the invention applies to the third aspect of the invention as well, except as otherwise indicated hereinbelow.

With reference to FIG. 13, the video sharing takes place as follows: the computing device 110 is configured to generate the first screen image and the second screen image so as to represent respective parts of a virtual area. A second image signal is generated 1040 by placing representations the elements selected for sharing in an image space covered by the secondary display, and sent to the intermediary device 130. The computing device 110 also sends 1050 information indicative of the placement to the intermediary device 130.

The intermediary device 130 extracts 1070 the one or more elements from the second screen image in accordance with the information indicative of the placement. The intermediary device 130 then generates 1100 a third image signal representing a third screen image, the third screen image including a representation of the one or more elements. The intermediary device 130 then sends 1110 the third image signal to the shared display 140 connected to the intermediary device 130.

Like the first aspect of the invention, this third aspect of the invention can be implemented using the “desktop extension” mode of driving the secondary display of the computing device 110, whereby the sharing software preferably causes the entire screen area of the secondary display to be covered by a suitably arranged rendering of the element(s) to be shared. Specific practical aspects of the use of the “desktop extension” were described above in the context of the first aspect of the invention and apply here as well.

Whereas it is a limitation of the second aspect of the invention that elements that are not visible on the primary display 120, e.g. occluded portions of application windows or images stored on the computing device 110 but not actively being rendered, are not accessible to the intermediary device 130 for sharing, this limitation is not present in the third aspect of the invention.

As in the second aspect of the invention, the one or more elements are preferably processed 1080 at the intermediary device 130 prior to the generating 1100 of the third image signal. As in the second aspect of the invention, the method according to this embodiment may further include, at the computing device 110, sending 1060 processing instructions to the intermediary device 130; and, at the intermediary device 130, processing 1090 the one or more elements prior to the generating 1100 of the third image signal in accordance with the processing instructions. The optional details and advantages of these features are as described above in the context of the second aspect of the invention.

FIG. 14 presents an example of contents of the primary display 120 of the computing device 110 (i.e., a first screen image 121), in which two specific application windows (labeled “Shared window A” and “Shared window B”) are selected for sharing. The computing device 110 operates a virtual secondary display in “desktop extension” mode, thus creating a second screen image 122 that serves as a canvas, invisible to the end user, on which the selected content can be pre-rendered prior to relaying it to the intermediary device 130 (left side of the white arrow). It should be noted that the rendering of content on the virtual secondary display is independent of what is shown on the primary display 120. Thus, it is immaterial that the “Shared window B” is not fully contained in the first screen image 121. As the sharing is performed by sharing software running on the computing device 110, it is possible to locally access application information and files, and render the content to be shared directly onto the virtual secondary display (second screen image 122) for sharing purposes. In this example, that advantage is used to declutter the image prior to sending it to the intermediary device 130: the shared application windows are pre-processed by removing their title bars and scaling them to such an extent that they can take up the maximum amount of space on the second screen image 122 without overlapping. The position of the individual shared elements in the resulting arrangement will be used as selection data that is relayed, together with the second screen image 122, to the intermediary device 130. The information may be conveyed in the form of coordinates of at least two corners of the respective rectangles that match the selected windows. Using this selection information, the intermediary device 130 extracts 1070 the appropriate portions of the second screen image 122, processes 1080 them, and renders 1100/1110 them as a third screen image 123g/h/i on the shared display 140. Examples of the processing 1080 include scaling the shared windows to the same size, moving them side by side, and placing them on a neutral background (123g); scaling the shared windows differently to emphasize one window relative to the other one, moving them side by side, and placing them on a neutral background (123h); and scaling the shared windows to the same size, placing one above the other, and moving the pair to one side of the screen to free up space for other content (123i).

The way in which various shared elements are selected for effective rendering and/or represented relative to each other (relative size, positioning, and emphasis) during the rendering step 1100/1110, may, without limitation, be determined by the intermediary device 130 on the basis of hard-coded or configurable rules, a hierarchy between computing devices or between types of content, additional metadata sent for this purpose by the computing device, or an artificially intelligent agent using machine learning and user feedback to build a selection strategy.

The present invention also relates to a computer program product comprising code means configured to cause a computer to perform the steps to be performed by the computing device 110 in any one of the aspects of the invention described above. The code means may additionally cause a computer to carry out steps indicated as optional in the foregoing description. The code means may be configured to effect some or all steps by interacting with the operating system. The code means may be configured to effect some or all steps by receiving input from a user via a user interface.

The present invention also relates to a computer configured to perform the steps to be performed by the computing device 110 in any one of the aspects of the invention described above. The computer may additionally be configured to carry out steps indicated as optional in the foregoing description. The computer may be configured to effect some or all steps by receiving input from a user via a user interface.

The present invention also relates to a peripheral configured to perform the steps to be performed by the intermediary device 130 in the second aspect and/or the third aspect of the invention. The peripheral may be equipped with suitable wired and/or wireless interfaces as described hereinabove. The peripheral may additionally be configured to carry out steps indicated as optional in the foregoing description. The functions of the peripheral may implemented, without limitation, by means of: programmable components, such as processors, with suitable programming; configurable components, such as FPGAs; dedicated hardware components, such as ASICs; and combinations thereof. The peripheral may be configured to also perform other functions than the ones described in the present application.

The present invention also relates to a system for selectively displaying audiovisual content, the system comprising a computer and a peripheral as defined in the preceding paragraphs and a shared display 140, operatively connected to said peripheral.

The combinations of features defined by the following numbered clauses constitute embodiments of the present invention and non-claimed alternatives with the technical effects as described hereinabove, and are expressly made part of the present disclosure:
1. A method of selectively displaying audiovisual content from a computing device (110) on a shared display (140), said computing device (110) having a primary display (120), said computing device (110) further being capable of controlling a real or virtual secondary display,
the method comprising at said computing device (110):
   sending (1010) a first image signal representing a first screen image (121) to said primary display (120);
   obtaining (1020) a selection of one or more elements to be shared ; and
generating (1040) a second image signal representing a second screen image (122) for display at said secondary display, said second screen image including a representation of said one or more elements,
wherein said shared display (140) is operatively connected to said computing device (110) and said computing device (110) is configured to control said shared display (140) as said secondary display;
wherein said computing device (110) is configured to generate said first screen image (121) and said second screen image (122) independently; and
wherein said generating (1040) of said second image signal comprises placing said representation of said one or more elements in an image space covered by said secondary display.
2. The method according to clause 1, wherein said computing device (110) is configured to generate said first screen image (121) and said second screen image (122) so as to represent respective parts of a virtual area.
3. The method according to clause 1 or clause 2, further comprising, at said computing device (110):
   processing (1030) said one or more elements prior to said generating (1040) of said second image signal, by performing one or more of:
      altering relative or absolute positions of said one or more elements;
      scaling said one or more elements;
      altering a title bar of an application window comprised in said one or more elements;
      altering a menu bar of an application window comprised in said one or more elements;
      altering a portion of one of said one or more elements that is not associated with a main application window comprised in said one of said one or more elements;
      altering a portion of the one or more elements in order to adapt to a current context; and
      altering a portion of said one or more elements that is determined to contain sensitive information.
4. The method according to any of the preceding clauses, wherein said generating (1040) of said second image signal comprises combining said one or more elements with content received from a different source.
5. The method according to any of the preceding clauses, wherein said shared display (140) is connected to said computing device (110) by means of one of an analog video connector, a DVI connector, an HDMI connector, and a USB-C connector preferably operating according to alternate mode.
6. The method according to any of clauses 1-5, wherein said computing device (110) is equipped with a wireless dongle (115), wherein said shared display (140) comprises or is connected to a wireless receiver (145), and wherein said operative connection between said computing device (110) and said shared display (140) includes a wireless link between said wireless dongle (115) and said wireless receiver (145).

7. A method of selectively displaying audiovisual content from a computing device (110) on a shared display (140), said computing device (110) having a primary display (120), said computing device (110) further being capable of controlling a real or virtual secondary display,
the method comprising at said computing device (110):
   sending (1010) a first image signal representing a first screen image (121) to said primary display (120);
   obtaining (1020) a selection of one or more elements to be shared; and generating (1040) a second image signal representing a second screen image (122) for display at said secondary display, said second screen image including a representation of said one or more elements,
wherein said shared display (140) is operatively connected to an intermediary device (130) and said intermediary device (130) is operatively connected to said computing device (110), said computing device (110) being configured to control said intermediary device (130) as said secondary display;
wherein said computing device (110) is configured to use a copy of said first screen image (121) as said second screen image (122);
the method further comprising, at said computing device (110):
   sending (1050) information indicative of said selection to said intermediary device (130);
the method further comprising, at said intermediary device (130):
   extracting (1070) said one or more elements from said second screen image (122) in accordance with said information indicative of said selection;
   generating (1100) a third image signal representing a third screen image (123a-f), said third screen image (123a-f) including a representation of said one or more elements;
   sending (1110) said third image signal to said shared display (140) connected to said intermediary device (130).
8. The method according to clause 7, further comprising, at said intermediary device (130):
   processing (1080) said one or more elements prior to said generating (1100) of said third image signal, by performing one or more of:
      altering relative or absolute positions of said one or more elements;
      scaling said one or more elements;
      altering a title bar of an application window comprised in said one or more elements;
      altering a menu bar of an application window comprised in said one or more elements;
      altering a portion of one of said one or more elements that is not associated with a main application window comprised in said one of said one or more elements;
      altering a portion of the one or more elements in order to adapt to a current context; and
      altering a portion of said one or more elements that is determined to contain sensitive information.
9. The method according to clause 7 or clause 8, further comprising:
   at said computing device (110): sending (1060) processing instructions to said intermediary device (130); and
   at said intermediary device (130): processing (1090) said one or more elements prior to said generating (1100) of said third image signal in accordance with said processing instructions.
10. The method according to any of clauses 7-9, wherein said generating (1100) of said third image signal comprises combining said one or more elements with content received from a different source.
11. The method according to any of clauses 7-10, wherein said intermediary device (130) is connected to said computing device (110) by means of a USB-C connector, operating according to alternate mode.
12. A method of selectively displaying audiovisual content from a computing device (110) on a shared display (140), said computing device (110) having a primary display (120), said computing device (110) further being capable of controlling a real or virtual secondary display,
the method comprising at said computing device (110):
   sending (1010) a first image signal representing a first screen image (121) to said primary display (120);
   obtaining (1020) a selection of one or more elements to be shared; and
generating (1040) a second image signal representing a second screen image (122) for display at said secondary display, said second screen image including a representation of said one or more elements,
wherein said shared display (140) is operatively connected to an intermediary device (130) and said intermediary device (130) is operatively connected to said computing device (110), said computing device (110) being configured to control said intermediary device (130) as said secondary display;
wherein said computing device (110) is configured to generate said first screen image (121) and said second screen image (122) independently;
wherein said generating (1040) of said second image signal comprises placing said representation of said one or more elements in an image space covered by said secondary display;
the method further comprising, at said computing device (110):
   sending (1045) information indicative of said placement of said representation of said one or more elements to said intermediary device (130);
the method further comprising, at said intermediary device (130):
   extracting (1070) said one or more elements from said second screen (122) image in accordance with said information indicative of said placement;
   generating (1100) a third image signal representing a third screen image (123g-i), said third screen image (123g-i) including a representation of said one or more elements; and
   sending (1110) said third image signal to said shared display (140) connected to said intermediary device (130).
13. The method according to clause 12, wherein said computing device (110) is configured to generate said first screen image (121) and said second screen image (122) so as to represent respective parts of a virtual area.
14. The method according to clause 12 or clause 13, further comprising, at said intermediary device (130):
   processing (1055) said one or more elements prior to said generating of said third image signal, by performing one or more of:
      altering relative or absolute positions of said one or more elements;
      scaling said one or more elements;
      altering a title bar of an application window comprised in said one or more elements;
      altering a menu bar of an application window comprised in said one or more elements;
      altering a portion of one of said one or more elements that is not associated with a main application window comprised in said one of said one or more elements;
      altering a portion of the one or more elements in order to adapt to a current context; and
      altering a portion of said one or more elements that is determined to contain sensitive information.
15. The method according to clause 13 or clause 14, wherein said generating (1100) of said third image signal comprises combining said one or more elements with content received from a different source.
16. The method according to any of clauses 12-15, wherein said intermediary device (130) is connected to said computing device (110) by means of a USB-C connector, operating according to alternate mode.
17. A computer program product comprising code means configured to cause a computer to perform the steps to be performed by the computing device in the method according to any of clauses 1-16.
18. A computer (110) configured to perform the steps to be performed by the computing device in the method according to any of clauses 1-16.
19. A peripheral (130) configured to perform the steps to be performed by the intermediary device in the method according to any of clauses 7-16.
20. A system (100) for selectively displaying audiovisual content, the system comprising:
a computer (110) configured to perform the steps to be performed by the computing device in the method of any of clauses 7-16; and
a peripheral (130), operatively connected to said computer (110) and configured to perform the steps to be performed by the intermediary device in the method of any of clauses 7-16; and
display (140), operatively connected to said peripheral (130).

While the various aspects of the present invention have been described hereinabove with reference to specific embodiments, this was done to clarify and not to limit the invention, the scope of which is defined by the attached claims.

1. A method of selectively displaying audiovisual content from a computing device on a shared display, said computing device having a primary display, said computing device further being capable of controlling a real secondary display,
the method comprising at said computing:
sending a first image signal representing a first screen image said primary display;
obtaining a selection of one or more elements to be shared; and generating second image signal representing a second screen image for display at said secondary display, said second screen image including a representation of said one or more elements,
wherein said shared display is operatively connected to said computing device and said computing device is configured to control said shared display as said secondary display;
wherein said computing device is configured to generate said first screen image and said second screen image independently; and wherein said generating of said second image signal comprises placing said representation of said one or more elements in an image space covered by said secondary display.

2. The method according to claim 1, wherein:
a user of said computing device is prevented from actively positioning content on the secondary display, or content that is placed there by the user is automatically repositioned on the primary display; or
the existence of the secondary display is made completely invisible to said user by an operating system of said computing device.

3. The method according to claim 1, wherein said computing device is configured to generate said first screen image and said second screen image so as to represent respective parts of a virtual area.

4. The method according to claim 1 further comprising, at said computing device:
processing said one or more elements prior to said generating of said second image signal, by performing one or more of:
altering relative or absolute positions of said one or more elements;
scaling said one or more elements;
altering a title bar of an application window comprised in said one or more elements;
altering a menu bar of an application window comprised in said one or more elements;
altering a portion of one of said one or more elements that is not associated with a main application window comprised in said one of said one or more elements;
altering a portion of the one or more elements in order to adapt to a current context; and
altering a portion of said one or more elements that is determined to contain sensitive information.

5. The method according to claim 1, wherein said generating of said second image signal comprises combining said one or more elements with content received from a different source.

6. The method according to claim 1, wherein said shared display is connected to said computing device by means of one of an analog video connector, a DVI connector, an HDMI connector, and a USB-C connector preferably operating according to alternate mode.

7. The method according to claim 1, wherein said computing device is equipped with a wireless dongle, wherein said shared display comprises or is connected to a wireless receiver, and wherein said operative connection between said computing device and said shared display includes a wireless link between said wireless dongle and said wireless receiver.

8. A method of selectively displaying audiovisual content from a computing device on a shared display, said computing device having a primary display, said computing device further being capable of controlling a real secondary display,
the method comprising at said computing device:
sending a first image signal representing a first screen image to said primary display;
obtaining a selection of one or more elements to be shared; and
generating a second image signal representing a second screen image for display at said secondary display, said second screen image including a representation of said one or more elements,
wherein said shared display is operatively connected to an intermediary device and said intermediary device is operatively connected to said computing device, said computing device being configured to control said intermediary device as said secondary display;
wherein said computing device is configured to generate said first screen image and said second screen image independently;
wherein said generating of said second image signal comprises placing said representation of said one or more elements in an image space covered by said secondary display;
the method further comprising, at said computing device
sending information indicative of said placement of said representation of said one or more elements to said intermediary device;
the method further comprising, at said intermediary device:
extracting said one or more elements from said second screen image in accordance with said information indicative of said placement;
generating a third image signal representing a third screen image, said third screen image including a representation of said one or more elements; and
sending said third image signal to said shared display connected to said intermediary device.

9. The method according to claim 8, wherein:
a user of said computing device is prevented from actively positioning content on the secondary display, or content that is placed there by the user is automatically repositioned on the primary display; or
the existence of the secondary display is made completely invisible to said user by an operating system of said computing device.

10. The method according to claim 8, wherein said computing device is configured to generate said first screen image and said second screen image so as to represent respective parts of a virtual area.

11. The method according to claim 8, further comprising, at said intermediary device:
processing said one or more elements prior to said generating of said third image signal, by performing one or more of:
altering relative or absolute positions of said one or more elements;
scaling said one or more elements;
altering a title bar of an application window comprised in said one or more elements;
altering a menu bar of an application window comprised in said one or more elements;
altering a portion of one of said one or more elements that is not associated with a main application window comprised in said one of said one or more elements;
altering a portion of the one or more elements in order to adapt to a current context; and
altering a portion of said one or more elements that is determined to contain sensitive information.

12. The method according to claim 8, wherein said generating of said third image signal comprises combining said one or more elements with content received from a different source.

13. The method according to claim 8, wherein said intermediary device is connected to said computing device by means of a USB-C connector, operating according to alternate mode.

14. A computer program product comprising code means configured to cause a computer to perform the steps to be performed by the computing device in the method according to claim 1.

15. A computer configured to perform the steps to be performed by the computing device in the method according to claim 1.

16. A peripheral configured to perform the steps to be performed by the intermediary device in the method according to claim 1.

17. A system for selectively displaying audiovisual content, the system comprising:
a computer configured to perform the steps to be performed by the computing device in the method of claim 8; and
a peripheral, operatively connected to said computer and configured to perform the steps to be performed by the intermediary device in the method of claim 8; and
display, operatively connected to said peripheral.
